(19) United States
(12) Patent Application Publication
(10) Pub. No.: US 2026/0206777 A1
(43) Pub. Date: Jul. 23, 2026

(54) PACKAGED CUT FRESH GARLIC PRODUCT AND METHOD OF MAKING

(71) Applicant: SW Ingredients Holdings, LLC, Orlando, FL (US)

(72) Inventors: Joseph Eli Sanchez, Atascadero, CA (US); Lisa Beth Schwendner, Winter Garden, FL (US); Keith Price, Newport, MI (US)

(21) Appl. No.: 19/450,098

(22) Filed: Jan. 15, 2026

Related U.S. Application Data
(60) Provisional application No. 63/746,778, filed on Jan. 17, 2025.

(51) Int. Cl. A23B 7/157; A23B 7/04; A23B 7/148

(52) U.S. Cl. CPC A23B 7/157; A23B 7/04; A23B 7/148

(57) ABSTRACT

The present disclosure relates to a packaged cut fresh garlic product and methods of making.

### CROSS-REFERENCE TO RELATED APPLICATION

This application claims priority to U.S. Provisional Application No. 63/746,778, filed January 17, 2025, which is herein incorporated by reference in its entirety.

### BACKGROUND

Garlic (Allium sativum) is used worldwide for a variety of purposes, including culinary and medicinal purposes. The garlic plant’s bulb or head is the most used part of the plant. The bulb is typically made up of numerous fleshy sections called cloves. Garlic cloves are individually covered with a skin, also referred to as an inner skin or peel.

Garlic is sold to consumers in a variety of forms. Previously, fresh garlic (as opposed to dried or frozen) has been sold as a whole bulb. Fresh garlic has also been sold in a cut form, such as a minced form, which further reduces preparation of the garlic by the end user. Fresh minced garlic is typically provided in a container with a preservative medium, such as an aqueous solution containing a small about of citric acid. This medium prevents the growth of bacteria in the sugars and proteins that are released in the process of mincing the garlic. The medium also prevents the garlic from deteriorating and turning brown in color. Still further, the medium reduces or contains the odor released by the garlic when the garlic flesh is cut or minced. It is desirable to provide a low-odor cut fresh garlic product which can be sold to consumers without the need for a preservative medium.

### SUMMARY

The present disclosure relates to a packaged cut garlic product and methods of making.

In Example 1, a method of manufacturing packaged cut fresh garlic includes spraying ozonated water onto fresh garlic while simultaneously cutting the garlic to produce cut fresh garlic; transporting the cut fresh garlic to a second location; spraying ozonated water onto the cut fresh garlic at a second location; and packaging the cut fresh garlic in packaging having at least one modified OTR portion through which air from inside the packaging can exit the packaging.

In Example 2, the method of Example 1 wherein the fresh garlic is peeled fresh garlic.

In Example 3, the method of Example 2 wherein the peeled fresh garlic is hydrocooled with a water solution containing an oxidizer before cutting.

In Example 4, the method of Example 3 wherein the oxidizer is peracetic acid and the peeled fresh garlic is hydrocooled with a water solution containing about 25 parts per million (ppm) to about 225 ppm peracetic acid before cutting.

In Example 5, the method of Example 3 wherein the peeled fresh garlic has a core temperature from about 32 °F to about 38 °F (about 0 °C to about 3.33 °C) after being hydrocooled.

In Example 6, the method of Example 1 wherein the ozonated water sprayed onto the fresh garlic while simultaneously cutting the garlic has an ozone concentration of about 1.0 ppm ± 0.5 ppm.

In Example 7, the method of Example 1 wherein the method further includes dewatering the cut fresh garlic while simultaneously spraying the ozonated water onto the cut fresh garlic.

In Example 8, the method of Example 1 wherein spraying ozonated water onto the diced fresh garlic included spraying ozonated water containing 1.0 ppm ± 0.5 ppm ozone onto the cut fresh garlic.

In Example 9, the method of Example 1 wherein the cut fresh garlic has a surface moisture content of less than about 5 wt.% when packaged.

In Example 10, the method of Example 1 wherein the packaging does not include a desiccant pouch.

In Example 11, the method of Example 1 wherein the packaging has a headspace, and the headspace has an oxygen equilibrium concentration from about 0.5 wt.% to about 10 wt.%.

In Example 12, the method of Example 11 wherein the headspace has an oxygen concentration equal to approximately local atmospheric oxygen concentration during the packaging step and has an oxygen concentration from about 0.5 wt.% to about 10 wt.% three days after the packaging step.

In Example 13, the method of Example 1 wherein the cut fresh garlic has a core temperature greater than 32 °F and less than about 40 °F when it is packaged.

In Example14, a packaged garlic product includes cut fresh garlic; and a sealed plastic pouch enclosing the cut fresh garlic and having a headspace, wherein an oxygen equilibrium concentration of the headspace is from about 0.5 wt.% to about 10 wt.%.

In Example 15, the packaged garlic product of Example 14 wherein the oxygen equilibrium concentration of the headspace is from about 1.5 wt.% to about 5 wt.%.

In Example 16, the packaged garlic product of Example 14wherein a carbon dioxide equilibrium concentration of the headspace is about 10 wt.% to about 15 wt.%.

In Example 17, the packaged garlic product of Example 14 wherein the cut fresh garlic has a shelf life of at least 45 days and wherein the sealed plastic pouch does not contain a desiccant.

In Example 18, the packaged garlic product of Example 14 wherein the plastic pouch includes at least one modified OTR portion through which air inside the plastic pouch can exit the plastic pouch.

In Example 19, the packaged garlic product of Example 18 wherein the at least one modified OTR portion is a through hole.

In Example 20, the packaged garlic product of Example 14 wherein the sealed plastic pouch is a resealable plastic pouch.

While multiple embodiments are disclosed, still other embodiments of the present invention will become apparent to those skilled in the art from the following detailed description, which shows and describes illustrative embodiments of the invention. Accordingly, the drawings and detailed description are to be regarded as illustrative in nature and not restrictive.

### BRIEF DESCRIPTION OF THE DRAWINGS

FIG. 1 is a block diagram of an exemplary process.

FIG. 2 is a schematic diagram of an exemplary package.

### DETAILED DESCRIPTION

Garlic is used worldwide as a spice or seasoning for human consumption. Increasing, consumers in the United States and other countries, prefer to buy fresh garlic as compared to dried or powdered forms. Fresh, cut (i.e., minced or diced) garlic is a convenient form of garlic. However, cut fresh garlic that is not provided in container with a preservative medium has several drawbacks including a short shelf life and a strong odor. A cut fresh garlic product packaged without a preservative (i.e., preservative medium) is disclosed. A method of making is also disclosed.

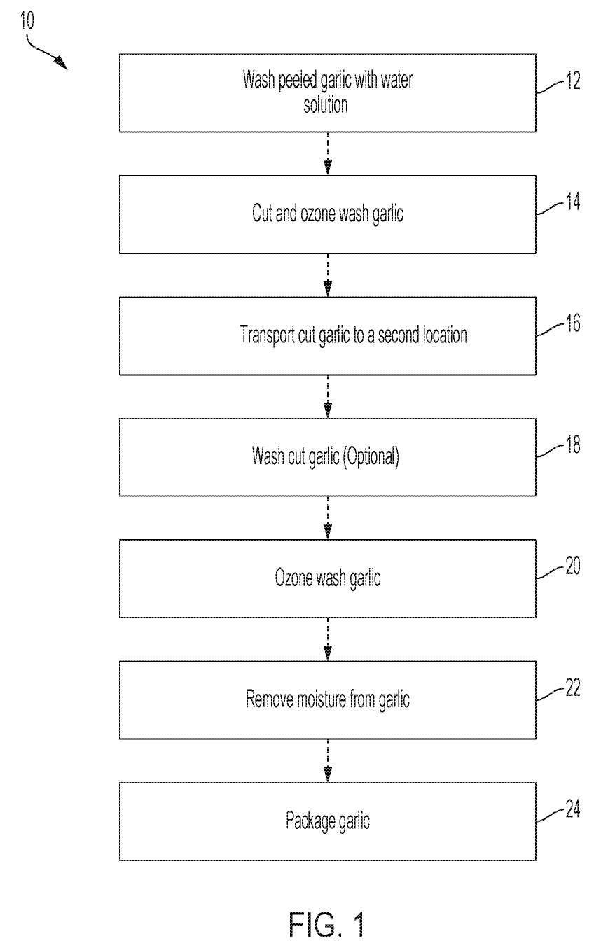

FIG. 1 is a block diagram of process 10 for cutting and packaging an odorous produce, such as garlic. Process 10 includes washing peeled garlic with a water solution (step 12), cutting and ozone washing the garlic (step 14), transporting the cut garlic to a second location (step 16), optionally washing the cut garlic with a water solution (step 18), ozone washing the garlic (step 20), removing moisture from the garlic (step 22) and packaging the garlic (step 24). Process 10 provides a packaged fresh, cut clove garlic product which does not require packaging containing a preservative medium. Further, while fresh, cut garlic is desirably aromatic, the packaged fresh, cut garlic has no or low odor detectable outside the packaging and has a sufficient shelf life. In some embodiments, the packed cut fresh garlic has a shelf life of at least 45 days and in some embodiments, at least 50 days.

In step 12, peeled garlic cloves are washed with a water solution. A garlic bulb is formed from a plurality of fleshy garlic cloves. Each clove is covered with a skin or a peel. The garlic cloves are separated from one another and are peeled as is known in the art. The peeled garlic is washed with a water solution. In some embodiments, the peeled garlic is hydrocooled. For example, the peeled garlic is washed with a chilled water solution. In some embodiments, the chilled water can be from about 32 °F to about 40 °F (from about 0 °C to about 4.44 °C) or from about 34 °F to about 38 °F (from about 1.11 °C to about 3.33 °C).

The water solution can contain a food-safe oxidizer. The oxidizer is a chemical agent that reduces, kills or inactivates pathogens, such as bacteria, viruses and fungi, by oxidizing their cellular components. Suitable oxidizers include peracetic acid, chlorine, chlorine dioxide (ClO₂) and combinations thereof. In some embodiments, the oxidizer is present in sufficient amount to control microbial growth on the garlic. For example, the water solution can contain from about 25 parts per million (ppm) to about 225 ppm peracetic acid. In some embodiments, the water solution consists of or consists essentially of water and the oxidizer.

The peeled garlic can be washed with the water solution in a vessel by spraying, showering, mixing or agitating the garlic with the water solution. In some embodiments, the showering, mixing, or agitation enhances contact between the garlic and water solution. The washing may also remove heat (i.e., cool) the peeled garlic. In some embodiments, the peeled garlic is washed with the water solution for a time sufficient for the peeled garlic to reach a core temperature of about 38 °F or less. For example, the peeled garlic can have a core temperature from about 32 °F to about 38 °F (about 0 °C to about 3.33 °C) or from 34 °F to about 38 °F (about 1.11 °C to about 3.33 °C). In some embodiments, the peeled garlic is washed with the water solution for a sufficient time to reach a core temperature of about 38 °F or less and to achieve microbial reduction.

Next, the chilled, peeled garlic is cut and washed with ozone. For example, the chilled, peeled garlic can be fed into an industrial food-grade cutting machine which has a cutting mechanism that cuts the garlic into smaller pieces. The cutting machine can dice the garlic. The diced garlic may have a cube or cuboid shape. For example, the diced garlic may have different side lengths (length, width and height). For example, the cutting mechanism can cut the garlic into cubes that are about 3/8^{th} inch (0.95 centimeters) on each side. In some embodiments, the cutting mechanism can dice the garlic into pieces that have side lengths ranging from about 3/32^{nd} inch (2.38 millimeters) to about 3/16^{th} inch (4.8 millimeters). In some embodiments, the diced garlic has at least one side that has a length greater than about 3 millimeters. In other embodiments, the cutting machine can mince the garlic. Minced garlic may have a cube or cuboid shape with side lengths varying from about 1 millimeter to about 3 millimeters or from about 1 millimeter to about 2.5 millimeters. The cutting mechanism can include one or more blades or other instruments for cutting the garlic. In one example, the cutting mechanism is a dicing mechanism that includes a plurality of blades arranged in a grid. The cutting mechanism can cut the garlic into uniformly or substantially uniformly sized pieces or can cut the garlic into random-sized pieces. In some embodiments, the garlic is not a puree; it does not have a smooth, creamy, homogenous consistency. Rather, the garlic may be finely chopped or ground but still retains some texture and small pieces.

An ozone wash is conducted at the same time as the cutting. For example, ozone water can be applied to the garlic and the cutting mechanism as the garlic cloves are cut. In one example, ozone water is sprayed onto the garlic and cutting mechanism while the garlic is simultaneously cut.

The ozone water can comprise ozone (O₃) which has been infused or dissolved into water. Ozone can be created when electricity is discharged through an oxygen source. In some embodiments, ozone can be produced by an ozone generator. The ozone is then mixed with water, for example by bubbling the ozone through the water. In some embodiments, the ozone wash can include about 1 ppm ± 0.5 ppm ozone or about 1 ppm ± 0.25 ppm ozone.

Sugars and proteins are released when the flesh of the garlic is cut. Spraying the ozone water onto the garlic as it is cut seals the cut surfaces. Additionally, or alternative, the ozone wash can prevent degradation of the garlic.

After cutting and ozone washing the garlic, the cut garlic can be transported to a second location in step 16 and optionally washed with a water solution in step 18. The second location may be adjacent to the cutting machine.

In embodiments in which the cut garlic is washed in step 18, the water can be un-chilled (i.e., at room temperature) or a chilled water solution. When step 18 is performed, the step can be performed during the transportation, such that step 16 and step 18 occur simultaneously. For example, the water solution can be used to transport the cut garlic to the second location. Additionally, or alternatively, the cut garlic can be washed with the water solution at the second location such that step 18 occurs after step 16. In some embodiments, the chilled water can be from about 32 °F to about 40 °F (from about 0 °C to about 4.44 °C) or from about 34 °F to about 38 °F (from about 1.11 °C to about 3.33 °C).

The water solution of step 18 can optionally contain an oxidizer such as peracetic acid, chlorine or chlorine dioxide. In some embodiments, the peracetic acid is present in sufficient amount to control microbial growth. For example, the water solution can contain from about 25 parts per million (ppm) to about 225 ppm peracetic acid. In some embodiments, the water solution consists of or consists essentially of water and the oxidizer.

In some embodiments, the water solution consists of or consists essentially of water and peracetic acid. In other embodiments, the water solution consists of or consists essentially of water. In some embodiments, the water solution of step 18 can have the same composition as the water solution of step 12. In other embodiments, the water solution used in step 18 and the water solution used in step 12 can have different compositions.

In some embodiments, when chilled water is used in step 18, the cut garlic is washed with the chilled water solution for a time sufficient for the cut garlic to reach a core temperature of about 38 °F or less. In some embodiments, the cut garlic is washed to achieve a core temperature of about 32° F to about 38 °F. In some embodiments, the cut garlic is washed by placing the cut garlic and the chilled water solution in a vessel. In some embodiments, the chilled water solution may be sprayed or showered into the vessel, or the vessel may be mixed or agitated to increase contact of the cut garlic and the chilled water solution. In some embodiments, the temperature of the chilled water solution of step 18 can be the same or about the same as the temperature of the water solution of step 12. In other embodiments, the temperature of the chilled water solution used in step 18 and the water solution used in step 12 are different.

The chilled water solution in step 18 cools the core temperature of the cut garlic. The cutting of step 14 can warm the temperature of the garlic, and the chilled water solution can reduce the core temperature of the garlic after cutting.

Additionally, natural juices can be released when fresh garlic is cut. The washing in step 18 can remove these juices from the surface of the garlic.

The garlic can be ozone washed in step 20. This step can be the second ozone washing step in process 10. The ozone wash includes contacting the cut garlic with water comprising infused or dissolved ozone. In some embodiments, the ozone wash can include from about 1 ppm ± 0.5 ppm ozone or about 1 ppm ± 0.25 ppm ozone. The ozone wash of step 20 may have the same or different concentration of ozone as step 14.

In some embodiments, the ozone wash of step 20 can be accompanied by dewatering the cut garlic.

The cut garlic can be placed on a vibratory conveyance surface, such as a vibratory shaker, and spray-washed with the ozone wash. The shaker or vibration can help provide a single layer of conveyance and agitation of the cut garlic so that the ozone wash can contact all surfaces of the cut garlic. The ozone wash of step 20 can provide additional benefits, enhancing the effectiveness of the ozone wash by increasing or improving coverage. In this way, the ozone wash of step 20 can further seal the cuts on the garlic and can prevent degradation of the garlic. In some embodiments, the ozone wash of step 20 may result in a further microbial reduction. One skilled in the art will recognize that other types of conveyance which provide singulation and agitation may also be suitable.

Alternatively, the cut garlic may be dewatered prior to and/or during the ozone wash. For example, the cut garlic can be separated from water by vibration or shaking before the ozone wash, by use of a vibratory screening, and may be further dewatered during the ozone wash by use of a vibratory conveyance surface.

In some embodiments, after the ozone wash of step 20, the cut garlic may contain excess moisture. In step 22, excess surface moisture is removed from the cut garlic. Suitable means for removing surface moisture include using an air dryer, such as a spin dryer or a fluidized bed. In some embodiments, the cut garlic can have an excess surface moisture of about 5 wt.% to about 1 wt.% or from about 3 wt.% to about 2 wt.% prior to packaging (i.e., after step 22). In some embodiments, the moisture or surface moisture of the garlic can be measured by a drying method. In other embodiments, the moisture content is determined by a moisture meter or a surface probe. One skilled in the art will recognize that step 22 may not be performed if the moisture content of the garlic after step 20 is acceptable.

If chilled water is not used in step 18, the cut garlic can be cooled prior to packaging the product. For example, the cut garlic can be cooled sufficiently for the cut garlic to reach a core temperature of about 38 °F or less prior to packaging. In one example, a chilled air fluidized bed can be used step 22 to chill and dry the cut garlic.

The cut garlic has an aroma. Process 10 is conducted to reduce but not eliminate the garlic aroma.

The cut garlic is packaged in step 24. The cut garlic is placed in a suitable packaging. In some embodiments, the packaging may only contain the cut garlic and air or gas(es). For example, the packaging does not contain any additional or separate preservatives. The cut garlic is packaged in packaging without a preservative medium. For example, the cut garlic is placed in the packaging without being submerged or otherwise in contact with an aqueous solution. In some embodiments, the packaging does not include a desiccant or carbon pouch. In some embodiments, the interior of the packaging consists of or consists essentially of gases (i.e., air) and the cut garlic product.

In some embodiments, the packaging is plastic packaging or pouch. For example, the packaging can be formed from rollstock or can be a preformed plastic pouch. Rollstock plastic is flexible packaging which is supplied on a large roll and can be converted into various packaging formats, such as pouches or containers. It offers customization, cost-effectiveness and compatibility with different packaging machines.

In some embodiments, the packaging is designed to maintain reduced oxygen levels in the headspace of the packaging. Garlic cloves respire. Respiration, a biological process that allows the garlic clove to take in oxygen and release carbon dioxide, maintains the cells’ metabolic functions and overall viability, even after the cloves have been harvested. In respiration, garlic cloves take in oxygen from the surrounding air through their cell membranes. Inside the cells, oxygen is used to break down glucose through a series of metabolic pathways. As the glucose is broken down, carbon dioxide is produced as a byproduct and is released back into the air through cell membranes. The rate of respiration affects the shelf life of garlic cloves. For example, higher respiration rates can lead to quicker deterioration than lower rates. Maintaining a reduced or low oxygen content in the headspace of the packaging can reduce the respiration rate of the garlic.

The packaging is designed to maintain reduced oxygen levels, but not an environment void of oxygen. If garlic cloves have no oxygen, they will undergo anaerobic respiration (i.e., fermentation). After a prolonged period, anaerobic respiration can cause cellular damage due to the buildup of toxic byproducts, tissue breakdown, decay and eventually spoilage of the garlic cloves. Additionally, the garlic may become more susceptible to microbial infections and mold growth.

Mesh or paper bags may allow too much airflow to the garlic and have been found to result in an undesired odorous product while in the package. That is, the packaged garlic may put off too much of an odor while in the packaging. For example, the packaged garlic may be too odorous while on the grocery store shelf or in the consumer’s refrigerator. Retailers and/or consumers do not want to smell garlic from the packaged garlic and/or have garlic flavor contaminate surrounding foods.

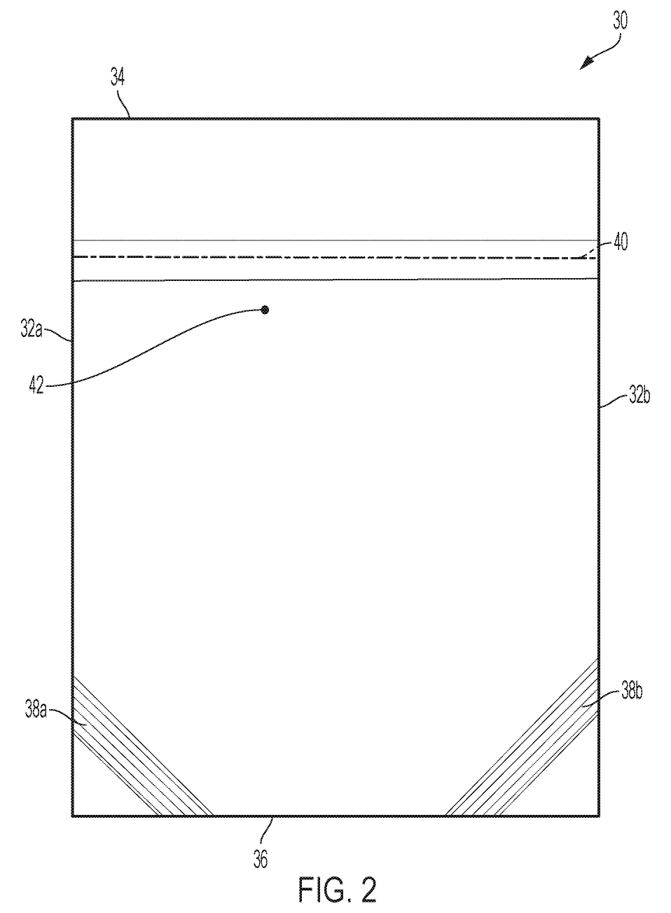

FIG. 2 is a schematic diagram of an exemplary packaging 30 for the cut garlic which includes sides 32a and 32b, top 34 and bottom 36. In some embodiments, packaging 30 is formed by folding a sheet of material to form bottom 36, and sides 32a and 32b are sealed, for example by using heat. This creates a pouch having an opening at top 34. Top 34 is sealed after the cut garlic has been placed inside packaging 30. In some embodiments, the opening of packaging 30 can be closed with resealable closure 40 to create a resealable packaging. One suitable resealable closure can consist of two interlocking plastic tracks that create an airtight and watertight seal when pressed together. Such a closure is known as a zipper lock, press-to-close seal or an interlocking seal. Other methods for creating an airtight seal may also be used. For example, a heat seal may be used to close packaging 30. In some embodiments, bottom 36 is folded along portions 38a and 38b to create a stand-up pouch as is known by one skilled in the art.

In one embodiment, packaging 30 has a least one modified oxygen transfer rate (OTR) portion 42 which has a different OTR than the base material of packaging 30. In some embodiments, air may flow through (i.e., into and out of) packaging 30 more easily through modified OTR portion 42 than through the base material. In some embodiments, modified OTR portion 42 is one or more micro-perforations. A micro-perforation or micro-perf can be any modification to the general construction of packing 30 that allows for a different oxygen transfer than the base material. In some embodiments, a micro-perf can be hole formed in packaging 30. In some embodiments, packaging 30 may be a multi-layer film or plastic and the micro-perf may be a hole through some but not all of the film layers. For example, a hole may be cut through two layers of a three-layer film. This configuration may have a higher OTR at the particular spot as compared to the remaining packaging. In other embodiments, the hole or conduit can be a through hole (or through conduit) which extends through all layers of the multi-layer film.

Various sizes, numbers and construction of micro-perfs can be used singularly or in combination to get the desired oxygen transfer rate. In some embodiments, the packaging 30 includes at least one micro-perforation (for example one or two) as modified OTR portion 42. In some embodiments, modified OTR portion 42 can be at least one hole or conduit (for example, one or two) in packaging 30 having a diameter of about 1 millimeter.

Modified OTR portion 42 allows atmosphere from outside packaging 30 to enter the packaging 30 and air from inside the packaging 30 to exit the packaging 30. In this way, the cut garlic can breathe in the packaging 30. In some embodiments, the packaging 30 is sealed such that the only pathway for airflow is through modified OTR portion 42. In some embodiments, modified OTR portion(s) 42 are sized to provide a small amount of airflow which prevents moisture buildup in the packaging 30 and allows the garlic to breathe while not allowing enough airflow out the of packaging 30 to create an obnoxious odor outside the packaging 30.

In some embodiments, the cut garlic is placed into the packaging 30 having at least one airflow conduit as the modified OTR portion 42. Initially, the headspace in the packaging 30 contains atmospheric air (approximately 21 wt.% oxygen and 0.04 wt.% carbon dioxide). The plastic packaging material, amount of headspace and the modified OTR portion(s) 42 are designed to maintain a predetermined oxygen transfer rate (OTR). As the garlic breathes or respirates, modified OTR portion 42 is sized or designed so that the oxygen content decreases and the carbon dioxide content increases. The oxygen and carbon dioxide concentrations will reach an equilibrium after a given amount of time. That is, modified OTR portion(s) 42 controls the flow of gas (such as oxygen and carbon dioxide) into and out of the packaging 30, and the oxygen and carbon dioxide reach steady state concentrations in packaging 30. In some embodiments, the oxygen equilibrium concentration is from about 0.5 wt.% to about 10 wt.% or from about 1.5 wt.% to about 5 wt.%. In some embodiments, the carbon dioxide equilibrium concentration is greater than zero and below 20wt.% or from about 10 wt.% to about 15 wt.% within packaging 30. In some embodiments, the equilibrium concentrations are reached within 3 days of packaging the garlic. For example, in some embodiments, the headspace of the packaging 30 has an oxygen concentration approximately equal to the local atmospheric oxygen concentration at the time of packaging and has an oxygen concentration from about 0.5 wt.% to about 10 wt.% when measured three days after the packaging step. In some embodiments, a headspace gas analyzer can be used to measure content of the air in the headspace.

The package head space oxygen content can be impacted by the initial head space oxygen content when the cut garlic is packaged, the OTR of packaging 30, the OTR of modified OTR portion(s) 42 and the respiration rate of the packaged cut garlic. The initial head space oxygen content is typically atmospheric air. However, the initial oxygen content can be modified by using a gas flushing technique such as nitrogen gas flushing.

The OTR of packaging 30 is dependent on a number of factors including the type of material or materials used and the construction of packaging 30. For example, different base materials of the packaging can have different OTRs. Further, different packaging formed from the same base material can have different OTRs. For example, a pre-formed pouch may have a different OTR than a vertical form-fill-seal produced pouch formed of the same material.

Where modified OTR portion(s) 42 are micro-perfs, the OTR of modified OTR portion(s) can dependent upon the size, quantity and construction of the micro-perfs. The OTR may not directly correlate to the number of opening or the size of an opening or hole. From an open area perspective, it would take four holes having 0.005 inch diameters to equal one hole having a 0.01 inch diameter. However, the OTR through those same size combinations may not be the same. The construction of the micro-perf can impact the oxygen transfer rate. For example, a hole formed by poking a hole in a film will have a rough opening and flow through the hole may be less effective than a hole formed by a laser cut, which will have a smoother opening.

The respiration rate of the cut garlic can depend upon the temperature of the cut garlic. In some embodiments, the garlic has a core temperature of greater than 32 °F and less than or equal to about 40 °F or 38 °F when it is packaged. Lowering the core temperature of the cut garlic can reduce the respiration rate of the garlic. In some embodiments, the cut garlic is packaged and is maintained or stored at a temperature of greater than 32 °F and less than or equal to about 40 °F or 38 °F.

After manufacturing and packaging, the packaged cut fresh garlic product can be placed into shipping contained, stored in cold storage and shipped to distribution and/or retail locations where it is eventually sold to consumers. In some embodiments, the airflow conduit or micro-perforations are positioned so that they are blocked during transportation or distribution. As explained above, these features of the packaging are designed to provide a determined amount of airflow to the packaged garlic and blockage of these features could result in the garlic using up all available oxygen in the packaging (i.e., the oxygen content of the headspace would be zero).

The cut garlic product is sold to consumers as a fresh product. The cut garlic product is not cooked, frozen, dried, freeze-dried or otherwise processed. It is in cut form. It is smaller than a whole head or clove of garlic and the garlic flesh has been damaged or sliced through. Consumers may further process the garlic after purchase. For example, by mincing or other chopping or cutting means. The packaged cut fresh garlic can be provided in a pouch with air; no other liquid or gas is required in the pouch. Initially, the air in the pouch is atmospheric air. However, the makeup of the air changes due to the garlic respiration.

The packaged cut garlic product has a shelf life of at least 45 days. The shelf life of garlic can refer to the duration for which garlic remains fresh, safe to eat, and retains its desired qualities such as flavor, texture, and nutritional value under proper storage conditions. For point of reference, peeled garlic stored in an airtight container in a refrigerator can have a shelf life of 1 to 2 weeks, and diced or chopped garlic stored in the same manner may be a shelf life of a few days. Signs of spoilage include mold (i.e., visible mold growth on the garlic), softness (i.e., the garlic becoming soft or mushy) and an off odor (i.e., a sour or unusual smell).

While garlic is used in the above examples, other produce, and in particular, other odorous produce, such as onions, may also be cut and packaged using the disclosed method.

As used herein, the term “about” means ± 10%, ± 5% or ± 1%.

Various modifications and additions can be made to the exemplary embodiments discussed without departing from the scope of the present invention. For example, while the embodiments described above refer to particular features, the scope of this invention also includes embodiments having different combinations of features and embodiments that do not include all of the above described features.

The following is claimed:

1. A method of manufacturing packaged cut fresh garlic, the method comprising:
spraying ozonated water onto fresh garlic while simultaneously cutting the garlic to produce cut fresh garlic;
cutting the garlic to produce cut fresh garlic;
transporting the cut fresh garlic to a second location;
spraying ozonated water onto the cut fresh garlic at a second location; and
packaging the cut fresh garlic in packaging having at least one modified oxygen transfer rate (OTR) portion through which air from inside the packaging can exit the packaging.

2. The method of claim 1 and wherein the fresh garlic is peeled fresh garlic.

3. The method of claim 2 wherein the peeled fresh garlic is hydrocooled with a water solution containing an oxidizer before cutting.

4. The method of claim 3 wherein the oxidizer is peracetic acid and the peeled fresh garlic is hydrocooled with a water solution containing about 25 to about 225 parts per million (ppm) peracetic acid before cutting.

5. The method of claim 3 wherein the peeled fresh garlic has a core temperature from about 32 °F to about 38 °F (about 0 °C to about 3.33 °C) after being hydrocooled.

6. The method of claim 1 wherein the ozonated water sprayed onto the fresh garlic while simultaneously cutting the garlic has an ozone concentration of about 1.0 ppm ± 0.5 ppm.

7. The method of claim 1 wherein the method further includes dewatering the cut fresh garlic while simultaneously spraying the ozonated water onto the cut fresh garlic.

8. The method of claim 1 wherein after cutting, spraying ozonated water onto the diced fresh garlic includes spraying ozonated water containing 1.0 ppm ± 0.5 ppm ozone onto the cut fresh garlic.

9. The method of claim 1 wherein the cut fresh garlic has a surface moisture content of less than about 5 wt.% when packaged.

10. The method of claim 1 wherein the packaging does not include a desiccant pouch.

11. The method of claim 1 wherein the packaging has a headspace, and the headspace has an oxygen equilibrium concentration from about 0.5 wt.% to about 10 wt.%.

12. The method of claim 11 wherein the headspace has an oxygen concentration equal to approximately local atmospheric oxygen concentration during the packaging step and has an oxygen concentration from about 0.5 wt.% to about 10 wt.% three days after the packaging step.

13. The method of claim 1 wherein the cut fresh garlic has a core temperature greater than 32 °F and less than about 40 °F when it is packaged.

14. A packaged garlic product, the product comprising:
cut fresh garlic; and
a sealed plastic pouch enclosing the cut fresh garlic and having a headspace, wherein an oxygen equilibrium concentration of the headspace is from about 0.5 wt.% to about 10 wt.%.

15. The packaged garlic product of claim 14 wherein the oxygen equilibrium concentration of the headspace is from about 1.5 wt.% to about 5 wt.%.

16. The packaged garlic product of claim 14 wherein a carbon dioxide equilibrium concentration of the headspace is about 10 wt.% to about 15 wt.%.

17. The packaged garlic product of claim 14 wherein the cut fresh garlic has a shelf life of at least 45 days and wherein the sealed plastic pouch does not contain a desiccant.

18. The packaged garlic product of claim 14 wherein the plastic pouch includes at least one modified OTR portion through which air inside the plastic pouch can exit the plastic pouch.

19. The packaged garlic product of claim 18 wherein the at least one modified OTR portion is a through hole.

20. The packaged garlic product of claim 14 wherein the sealed plastic pouch is a resealable plastic pouch.
